(19) United States
(12) Patent Application Publication
(10) Pub. No.: US 2024/0367619 A1
(43) Pub. Date: Nov. 7, 2024

(54) ROOF MODULE FOR FORMING A VEHICLE ROOF HAVING A CLEANING APPARATUS

(71) Applicant: Webasto SE, Stockdorf (DE)

(72) Inventors: Maximilian EHRMANN, Stockdorf (DE); Magnus SVIBERG, Stockdorf (DE); Cèdric LANGLAIS, Stockdorf (DE); Michael HUELSEN, Stockdorf (DE); Thomas PODOLSKI, Stockdorf (DE); Dirk AUERSWALD, Stockdorf (DE)

(21) Appl. No.: 18/687,113

(22) PCT Filed: Mar. 17, 2022
(86) PCT No.: PCT/EP2022/057043

§ 371 Date: Feb. 27, 2024

(30) Foreign Application Priority Data
Sep. 3, 2021 (DE) 10 2021 122 858.1

(51) Int. Cl. B60S 1/56; B60S 1/02; B60S 1/54; B62D 25/06; G02B 27/00

(52) U.S. Cl. CPC B60S 1/56; B60S 1/026; B60S 1/54; B62D 25/06; G02B 27/0006

(57) ABSTRACT

A roof module for forming a vehicle roof on a motor vehicle, the roof module having a panel component, whose outer surface forms at least sections of a roof skin of the motor vehicle, the roof skin acting as an outer sealing surface of the roof module, the roof module having at least one environment sensor which sends and/or receives electromagnetic signals for charting the vehicle environment via a see-through area and having at least one cleaning apparatus by which the see-through area is cleaned. The cleaning apparatus may have an essentially oblong nozzle body having a plurality of ejection nozzles and/or flow guiding contour formed by the panel component or by the environment sensor.

### CROSS-REFERENCE TO RELATED APPLICATIONS

This application is a U.S. national phase application filed under 35 U.S.C. § 371 of International Application No. PCT/EP2022/057043, filed on Mar. 17, 2022, published under WO 2023/030697A1 on Mar. 9, 2023, designating the United States, which claims priority from German Patent Application Number 10 2021 122 858.1, filed on Sep. 3, 2021, which are hereby incorporated herein by reference in their entirety.

### FIELD

The invention relates to a roof module for forming a vehicle roof on a motor vehicle according to the preamble of claim 1.

### BACKGROUND

Generic roof modules are widely used in vehicle manufacturing, since these roof modules can be prefabricated as separate functional modules and can be delivered to the assembly line when assembling the vehicle. The roof module at least partially forms a roof skin of the vehicle roof at its outer surface, the roof skin preventing moisture and air flows from entering the vehicle interior. The roof skin is composed of one or more panel components, which can be made of a stable material, such as painted metal or painted or solid-colored plastic. The roof module can be a part of a fixed vehicle roof or a part of an openable roof sub-assembly.

Furthermore, the development in vehicle manufacturing is increasingly focusing on autonomously and semi-autonomously driving motor vehicles. In order to enable the vehicle controller to control the motor vehicle autonomously or semi-autonomously, a plurality of environment sensors (e.g., lidar sensors, radar sensors, (multi-)cameras, etc. including other (electrical) components) and/or sensor modules are employed, which are integrated in the roof module, for example, and which chart the environment surrounding the motor vehicle and determine, for example, a current traffic situation from the acquired environment data. Roof modules which are equipped with a plurality of environment sensors are also known as roof sensor modules (RSM). For this purpose, the known environment sensors send and/or receive suitable electromagnetic signals, such as laser beams or radar beams, allowing a data model of the vehicle environment to be generated by suitable signal evaluation and to be used for controlling the vehicle.

The sensor modules, which comprise environment sensors for monitoring and charting the vehicle environment, are typically mounted on the vehicle roof, since the vehicle roof is typically the highest point of a vehicle, from where the vehicle environment is easily visible. The sensor modules are typically placed on top of the panel component of the roof module, which forms the roof skin, as attachments. During use of the environment sensor, there is a risk that a ((partially) transparent) see-through area, through which the environment sensor charts the vehicle surroundings, may become dirty or opaque for the environment sensor due to environmental influences (e.g. weather).

For cleaning the see-through area, the use of a cleaning apparatus is known, by means of which the see-through area can be cleaned. The known cleaning apparatuses are usually statically positioned on the outer surface of the roof skin in an area of the roof module and/or the panel component, similar to the spray nozzles of a windshield or headlight wiper system. The cleaning fluid used can be an aqueous soapsuds solution or alternatively a compressed gas, such as compressed air, cleaning using compressed air having the advantage to cleaning using an aqueous soapsuds solution in that no cleaning water needs to be removed from the cleaned surface and/or the roof module after cleaning.

A disadvantage of known compressed air cleaning systems is that the cleaning medium “compressed air” requires its own separate compressed air circuit, which usually consists of at least a compressor, a compressed air tank, a number of (inlet and/or outlet) valves and a plurality of cleaning nozzles. These components require a corresponding installation space, which can only be provided in a space-limited roof module installation space with a high level of design and construction effort. Alternatively, the compressed air components can also be relocated to an installation space in the remaining vehicle (e.g. in a trunk), but this space is also limited due to a plurality of other vehicle components on the one hand and on the other hand, it is then necessary to lay compressed-air lines into the installation space of the roof module, which represents a great deal of additional work, at least in terms of assembly and costs. In addition, the design effort and the installation space problem require a high level of coordination with the respective original equipment manufacturer (OEM), thus rendering the entire design and development process inefficient. A further problem is that the components required for the compressed air supply, in particular the compressor, have a high energy requirement, which must be provided by the vehicle's own energy source, usually the battery storage system and/or the combustion engine, which has a negative impact on the range of the vehicle.

Another disadvantage of existing compressed air cleaning systems is that a plurality of compressed-air cleaning nozzles is required to ensure efficient and comprehensive cleaning of the see-through area to be cleaned. The compressed-air cleaning nozzles are usually disposed on the outer surface of the roof skin at a short distance in front of the see-through area to be cleaned, several compressed-air cleaning nozzles per see-through area to be cleaned being aligned at different angles to each other and relative to the see-through area. Particularly in the event that a roof module comprises a number of environment sensors and therefore a number of see-through areas, a plurality of compressed-air cleaning nozzles must be disposed on the roof module, which results in an enormous amount of assembly work. In most cases, each individual compressed-air cleaning nozzle must be connected to at least one compressed-air distributor by means of a compressed-air line and must often be controlled via a separate valve of the nozzle. This requires a complex pneumatic system having a plurality of connection points to be installed in the roof module. This results in high installation costs. In addition, the installation of the plurality of components is difficult overall. The complexity of the system also increases the probability of failure, as individual components can fail, for example. A leak within the complex compressed-air system can, for example, lead to an overall failure of the compressed-air cleaning system, as it may no longer be possible to build up the necessary system pressure depending on the failed components. The plurality of compressed-air cleaning nozzles in the immediately in front of the see-through area can also lead to the compressed-air cleaning nozzles or their respective covers creating elevations on the roof skin which restrict the field of vision of the environment sensor and can lead to the formation of so-called “ghost images” or black spots in the charting area of the environment sensor. This has a negative impact on the functionality and charting accuracy of the environment sensor.

A further problem that environment sensors can be confronted with during their intended use is the possible icing of the see-through area in cold, frosty ambient conditions (at temperatures below zero (in ° C.)). Such icing or the formation of a layer of ice on the outer surface of the see-through area makes the see-through area, which is otherwise transparent for the environment sensor, opaque and thus opaque for the environment sensor. To solve this icing problem, it is generally known in automotive engineering to integrate a plurality of heating wires into windows. An applied voltage is used to generate a current flow through the heating wires, which heats up the heating wires. The heating of the heating wires causes the windshield to heat from the inside, meaning any layer of ice begins to melt and can ultimately be removed. This type of de-icing is also known in principle for the see-through area of an environmental sensor, but has the disadvantage that a see-through area manufactured in this manner requires a complex manufacturing process and the wires disposed in the see-through area also have a negative effect on the transmission or permeability of the see-through area. This again has a negative impact on the functionality and charting accuracy of the environment sensor, as it does not have an unobstructed view of the object to be detected in the areas where the heating wires are disposed in the see-through area. Due to the triangulation principle used for most environment sensors, this charting defect is amplified the further away a target to be detected is from the environment sensor. For this reason, the known heating wire-based solutions for de-icing a see-through area appear inadequate.

### SUMMARY

The first object of the invention is therefore to propose a roof module having a cleaning apparatus which avoids the disadvantages of the previously known prior art described above.

The object is attained by a roof module according to the teachings of claim 1.

Advantageous embodiments of the invention are the subject matter of the dependent claims.

The roof module for forming a vehicle roof on a motor vehicle comprises a panel component, whose outer surface forms at least sections of a roof skin of the motor vehicle, the roof skin acting as an outer sealing surface of the roof module. The roof module comprises at least one environment sensor which can send and/or receive electromagnetic signals for charting the vehicle environment via a see-through area and at least one cleaning apparatus by means of which the see-through area can be cleaned. The roof module according to the invention is characterized in that the cleaning apparatus comprises an essentially oblong nozzle body having a plurality of ejection nozzles and/or a flow guiding contour formed by the panel component or by the environment sensor.

Furthermore, the object is attained by a roof module for forming a vehicle roof on a motor vehicle. The roof module comprises a panel component, whose outer surface forms at least sections of a roof skin of the motor vehicle, which acts as an outer sealing surface of the roof module. The roof module further comprises at least one environment sensor which can send and/or receive electromagnetic signals for charting the vehicle environment via a see-through area and at least one cleaning apparatus. The cleaning apparatus comprises at least one ejection nozzle by means of which the see-through area can be cleaned. The roof module according to the invention is characterized in that the cleaning apparatus is connected to a fan, in particular to a fan of a vehicle cooling system, at least via a supply line so an air current generated by the fan is ejected from the at least one ejection nozzle for the purpose of cleaning and/or de-icing the see-through area. Particularly preferably, a fan of this kind is comprises in the roof module.

Alternatively, the fan (already provided in a motor vehicle) of an air-conditioning system of a motor vehicle can also preferably be used. It is understood that all configurations and embodiments can be used in an equivalent manner for both objects according to the invention, without being mentioned in redundant form.

According to the embodiment according to the invention, compared to the prior art, a plurality of compressed-air cleaning nozzles, which have to be installed with a high installation effort, is replaced by preferably an individual nozzle body comprising a plurality of ejection nozzles and/or by a flow guiding contour formed by the panel component or by the environment sensor. According to the invention, the ejection nozzle is thus provided by the flow guiding contour and/or by the plurality of ejection openings of the nozzle body. The nozzle body and/or the flow guiding contour formed by the panel component can thus be disposed and/or laid and/or mounted far more simply, as preferably only one connection, preferably to a fan, is required via a supply line.

The flow guiding contour is preferably formed by a suitable geometric design of the panel component or the environment sensor (or a casing of the environment sensor) in the area of the outlet of the cleaning fluid. This geometric design can be provided, for example, by an, in particular tapered, guide slit having one or more curves, through which the cleaning fluid can be deflected so that it is ejected in the direction of the see-through area. The flow guiding contour preferably forms an individual, continuous nozzle outlet.

Together with the plurality of ejection nozzles, the nozzle body forms an oblong multi-nozzle, as it were, which has only one nozzle body but a plurality of nozzle heads and/or ejection openings. In addition, the function of the plurality of separate compressed-air cleaning nozzles, which in the prior art had to be mounted individually on the roof skin of the roof module, can now preferably be taken over by a single nozzle body and/or by the flow guiding contour formed by the panel component. The nozzle body comprises the plurality of ejection nozzles. The plurality of ejection nozzles and/or the flow guiding contour preferably has the same functional cleaning effect as that which had to be provided in the prior art by the plurality of separate compressed-air cleaning nozzles.

Thus, the cleaning apparatus according to the invention is far simpler to install and reduces the installation effort and the resulting costs. Likewise, the cleaning apparatus according to the invention no longer necessarily has to be operated with compressed air, since the plurality of ejection nozzles in the nozzle body and/or the flow guiding contour having a preferred option of a directional flow guidance also makes it possible to clean the see-through area using an air current at a lower pressure level. This is particularly advantageous, as it means that compressed air components such as a compressor, a compressed air tank, a plurality of valves etc. are no longer required. As a result, a large volume of installation space can be saved compared to the prior art, which is advantageous in terms of design and construction. Overall, the solution according to the invention is therefore more compact and less expensive. In addition, the cleaning apparatus according to the invention has the advantage that the fluid flow and/or air current which can be provided by the cleaning apparatus can preferably also produce a de-icing effect on the see-through area. This is possible in particular because the air current which can be provided by the cleaning apparatus according to the invention can preferably already be preheated, in particular by waste heat from the environment sensor, and thus cause it to heat up when striking the see-through area. As a result, it is preferably possible to dispense with the arrangement of heating wires within the see-through area, which means the associated negative effects no longer occur. Rather, the nozzle body according to the invention can fulfill the function of both cleaning and de-icing, which has hitherto not been possible in the prior art. This synergetic relationship has an overall positive effect on the cost balance of the roof module according to the invention. Particularly preferably, the cleaning apparatus according to the invention, in particular by means of the flow guiding contour and/or the plurality of ejection nozzles, can direct a continuous air current to the see-through area, which can reduce soiling or the build-up of soiling. In this manner, the cleaning apparatus according to the invention can also preventively reduce a soiling of the see-through area in an energy-saving manner. Preferably, a continuous air film can be formed on the see-through area, which minimizes soiling of the see-through area. A further advantage of the solution according to the invention is that the waste heat used not only provides a de-icing function, but can also be used to dry the see-through area. This means, for example, that individual drops of water that may remain on the (outer) surface of the see-through area are dried better and therefore do not interfere with the view of the environment sensor. To provide such a drying function in the prior art, however, energy-intensive compressed air would have to be used, which can now be dispensed with according to the invention. A further significant advantage of the invention is that a constant noise emission from the fan causes a constant noise, which is quieter compared to compressed-air cleaning, in which noise is caused by the compressed air blasts. Such a noise is therefore perceived as less disturbing by the occupants, which improves overall ride comfort.

The cleaning apparatus according to the invention is less expensive, comprises fewer components compared to the prior art, is easier to modify and/or adjust, requires simpler control and can also dispense with a number of assembly steps. The solution according to the invention is also significantly easier to maintain and/or service.

In the present case, the phrase “at least one” is understood to mean that the roof module according to the invention can comprise one or more of the components in question. The phrase “essentially oblong” means that the nozzle body can preferably have an oblong basic shape, but does not necessarily have to be straight. Rather, the nozzle body can also have a curved shape and/or a shape following a predetermined contour, as long as it has a longitudinal extension greater than its width and/or height. The term “ejection nozzle” is understood here to mean a type of outlet opening. It is understood that the environment sensor can also be part of a sensor module which is comprised in the roof module and which can comprise the environment sensor as well as other electronic components and/or mechanical components (e.g. a casing, parts of a casing and/or a drive, etc.).

The roof module according to the invention can form a structural unit in which apparatuses for autonomous or semi-autonomous driving supported by driver assistance systems are integrated and which can be mounted as a unit on a vehicle body shell by a vehicle manufacturer. Furthermore, the roof module according to the invention can be designed as a purely fixed roof or as a roof including a roof opening system. In addition, the roof module can be designed for use in a passenger car or a commercial vehicle. The roof module can preferably be provided as a structural unit in the form of a roof sensor module (RSM), in which the environment sensors are provided in order to be inserted as a deliverable structural unit in a roof frame of a vehicle body.

In principle, the environment sensor of the roof module according to the invention can be designed in a variety of ways and comprise a lidar sensor, a radar sensor, an optical sensor, such as a camera, and/or the like. Lidar sensors operate in a wavelength range of 905 nm or even around 1,550 nm, for example. The material of the roof skin in the see-through area should be transparent for the wavelength range used by the environment sensor and should therefore be selected depending on the wavelength(s) used by the environment sensor with regard to the material.

In a preferred embodiment, the nozzle body is essentially tube- or hose-shaped, in particular having a hollow cross-section. The nozzle body can therefore preferably have the shape of a tube or at least be similar in shape to a tube. Alternatively, the nozzle body can preferably have the shape of a hose or at least be similar in shape to a hose. The design of the nozzle body as a tube or hose is particularly preferable, as these components are available as standard parts in a wide variety of dimensions, so that the nozzle body can be provided particularly cost-effectively. The standard components can then merely be reworked in order to be used in the cleaning apparatus according to the invention. It is preferable if the nozzle body comprises a hollow cross section. In this manner, air can be introduced into an inner cavity of the nozzle body in a simple manner, e.g. by means of a connection fitting, the air then being able to be ejected through the plurality of ejection nozzles. Particularly preferably, the nozzle body, as viewed in its longitudinal direction, is closed at one end so as to be impermeable to air, so that air flowing into the nozzle body is forced to escape from the nozzle body again through the plurality of ejection nozzles.

In a preferred embodiment, the plurality of ejection nozzles is provided in the form of a plurality of holes and/or slits in the nozzle body. The plurality of ejection nozzles can thus be provided, for example, by a plurality of drill holes (preferably having a drill hole diameter ranging from 0.1 mm to 2 mm) in the nozzle body. Preferably, a standard tube, which is preferably sealed at one end, can be machined with a precision drill so that a plurality of holes are drilled in the tube. These holes then form the plurality of ejection nozzles. Particularly preferably, the plurality of ejection nozzles is disposed in an area around a main axis of the nozzle body, the main axis extending along its longitudinal direction. Alternatively or additionally, it is also possible to provide the plurality of ejection nozzles by means of slits that can be milled into the nozzle body, for example. The slits preferably have dimensions ranging from 0.1 mm to 2 mm. Slits of this kind can be particularly preferred if the nozzle body is formed by a tube, since a tube of this kind can be slit in a simple manner (e.g. punctured by a pin cushion). Alternatively, it is also possible to use a laser to produce the plurality of ejection nozzles in the nozzle body. This has the advantage that, for example, conical cross sections of an ejection opening can also be produced so that the nozzle effect can be enhanced.

In a preferred embodiment, the plurality of ejection nozzles is disposed in such a manner in the nozzle body that the individual ejection nozzles are each oriented essentially in the same or a different direction in relation to the see-through area. For example, the individual ejection nozzles can be disposed in the same direction to one another, but have an angle of attack relative to the see-through area. The individual ejection nozzles can also be designed in such a manner that they have differing ejection angles. In this manner, the directional flow of an air current ejected from the plurality of ejection nozzles can also be predetermined by means of the respective ejection angle of the respective nozzle. Thus, depending on the shape of the see-through area and the arrangement of the nozzle body relative to the see-through area, a wide variety of air currents or flow profiles can be formed. The term “essentially in the same manner” means that the individual ejection nozzles can define the same ejection angle in the nozzle body for an outflowing air, baring any manufacturing inaccuracies in the production of the ejection nozzles. A respective ejection direction of the individual ejection nozzles preferably runs essentially perpendicular (i.e., 90°±10%) to a longitudinal main axis of the nozzle body.

In a preferred embodiment, the nozzle body is designed in the form of a tubular, in particular microporous (defines pores having a diameter of <2 nm), mesoporous (defines pores having a diameter between 2 nm and 50 nm) or macroporous (defines pores having a diameter of >50 nm) membrane, which can preferably be sealed in an air-impermeable manner at least in certain areas by means of a sealing lacquer layer. A membrane of this kind can, for example, be made of a microporous plastic or a microporous ceramic, so that a plurality of ejection nozzles are already formed during the manufacturing process due to the material and production process. By preferably sealing at least some areas of the membrane, a directed air outlet can be provided along an unsealed membrane area, for example, through which an air current can then escape in a directed manner from the plurality of microporous ejection openings and preferably be directed to the see-through area.

In a preferred embodiment, the at least one nozzle body having the plurality of ejection nozzles is oriented in such a manner in relation to the see-through area that an air current generated when cleaning and/or de-icing can strike the see-through area from the outside, preferably along a movement direction. In other words, the entire nozzle body is preferably oriented in such a manner in relation to the see-through area that an air current ejected from the nozzle body can strike the see-through area, preferably in its entirety, for the purpose of cleaning and/or de-icing. The orientation of the nozzle body in relation to the see-through area can be easily realized owing to the oblong extension of the nozzle body, since the nozzle body preferably only need be rotated around its longitudinal axis in order to orient the plurality of ejection nozzles with the see-through area. The plurality of ejection nozzles is preferably oriented essentially perpendicular to the longitudinal axis of the nozzle body, an orientation with respect to the see-through area can be achieved by rotating the nozzle body about its longitudinal axis.

In a preferred embodiment, the panel component, as viewed along an optical axis of the environment sensor, has an essentially oblong guide channel in front of the see-through area, the guide channel being at a rearward offset in the direction of a vehicle interior with respect to the outer surface of the roof skin and is configured for at least partially receiving the at least one nozzle body. In this embodiment, the nozzle body is therefore preferably disposed at least partially in the guide channel and can therefore also partially protrude from the guide channel (and also with respect to the roof skin). The guide channel can preferably be formed in the panel component while the panel component is manufactured (e.g. by deep drawing) by shaping the master mold accordingly. The guide channel preferably forms an assembly space for the nozzle body and can preferably essentially (i.e., minus manufacturing-and assembly-related tolerances) comprise the dimensions of the nozzle body. The guide channel can preferably comprise assembly aids, for example in the form of additional components or walls provided via its shape, for fastening the nozzle body in the guide channel. Preferably, the guide channel is dimensioned in such a manner that it can completely accommodate the nozzle body. Thus, it is prevented that a part of the nozzle body protrudes beyond the roof skin and thus forms an interfering contour for the environment sensor. The shape of the guide channel, in which the preferably tube- or hose-shaped nozzle body is disposed, means that an air current ejected from the plurality of ejection nozzles can preferably be oriented towards the see-through area of the environment sensor over as large an area as possible. The guide channel is preferably recessed into the roof skin in the form of a groove or channel, or is formed as a groove or channel by the panel component during manufacture.

In a preferred embodiment, the nozzle body is disposed in a stationary manner in the guide channel. In a particularly preferred embodiment, the nozzle body is pivotable in the guide channel at least in sections around a rotation axis, which preferably corresponds to its longitudinal axis. The nozzle body can rotate only about its rotational axis in the guide channel in relation to the roof module, this rotation preferably being limited to a predetermined segment about the rotational axis. The nozzle body can preferably be rotated by means of a control which controls a drive motor, which interacts with the nozzle body. The drive motor can be an electric servomotor, for example. By rotating the nozzle body, an ejected air current can be directed over a surface of the see-through area, for example, and can be focused on a specific area of the see-through area depending on the angle of rotation.

In a preferred embodiment, the at least one flow guiding contour is provided in an area of the guide channel and can guide an air current ejected from the plurality of ejection nozzles in the direction of the see-through area. The flow contour can, for example, already be formed as a kind of step or elevation by shaping the panel component accordingly. Alternatively, the flow contour can also be subsequently disposed in the area of the guide channel, e.g., glued to the panel component. In principle, the flow contour can have a variety of shapes (and/or cross sections). The decisive factor is that the flow contour helps to ensure the air current ejected from the plurality of ejection nozzles is oriented towards the see-through area in a manner that is as concentrated as possible. In the simplest case, the flow contour can, for example, be an oblong profile having a rounded outer surface, via which the air current is oriented and the air current is oriented in the guide channel. It is understood that, according to the invention, only the flow guiding contour can be provided as the outlet opening of the nozzle and therefore the oblong nozzle body is not necessarily required in order to orient the cleaning fluid as far as possible towards the see-through area. Alternatively or additionally to the plurality of outlet openings, the flow guiding contour can therefore also be used, for example as an oblong opening in the panel component.

In a preferred embodiment, the flow guiding contour is designed to form a constriction, through which the fluid flow can be accelerated in the direction of the see-through area. The constriction causes the air current to be accelerated due to a constriction of the flow cross-section, meaning the outflowing air is accelerated in the direction of the see-through area. This enables a more effective cleaning effect to be achieved. The flow guiding contour can therefore accelerate the cleaning fluid ejected from it in the direction of the see-through area, regardless of the presence of a guide channel and/or a nozzle body, meaning the see-through area is effectively cleaned.

In a preferred embodiment, the nozzle body is integrated in or disposed on a support element and/or carrier component. Alternatively or additionally (i.e., and/or), the nozzle body is movable in relation to the see-through area, in particular translationally and/or rotationally. It may also be possible to integrate the ejection nozzles in the support element, thus forming the nozzle body together with the ejection nozzles. The support element can be attached to the environment sensor or to a casing of the environment sensor. Alternatively or additionally, it is possible to attach the support element to a frame component and/or a structural part of the roof module frame and/or the body roof frame. This mobility of the nozzle body and/or the support element can, for example, be provided via an adjustment kinematic system and/or an adjustment drive, for example via one or more electric motors. For example, the nozzle body can be adjusted by an adjusting element which preferably moves the entire nozzle body and/or the oblong nozzle strip. For example, the nozzle body can be telescopically retracted and extended, i.e., be translationally movable. Mechanical and/or pneumatic drive solutions are also possible. Owing to the movable design of the nozzle body, it is possible, depending on the type of arrangement and movement, to retract the nozzle body at least partially in order to conceal it. The nozzle body can preferably also be designed to fold in and out. The nozzle body can preferably also be at least partially integrated in the support element or disposed on it. The nozzle body can preferably be disposed rigidly in relation to the support element or movably in relation thereto, the support element preferably being designed to be movable in relation to the see-through area. This ensures a high degree of freedom of design and/or movement. Preferably, as viewed from the environment sensor, the nozzle body is disposed in front of the environment sensor and/or laterally next to it, i.e. outside the field of view. Alternatively or additionally, the nozzle body can also be disposed as a stationary or permanently installed strip above, below and/or to the side of the sensor. Preferably, the nozzle body can be attached directly or indirectly to the panel component.

Particularly preferably, the cleaning apparatus has at least one supply line through which the cleaning fluid can be supplied to the nozzle outlet or the flow guiding contour. Particularly preferably, the nozzle body and/or the cleaning apparatus comprises several supply lines, which can preferably be exposed with to different cleaning fluids. For example, one supply line can be supplied with air, while the other supply line can be supplied with a liquid cleaning fluid. This allows the cleaning effect to be enhanced as required.

In a preferred embodiment, the roof module comprises a fan and preferably an air inlet. The fan is directly or indirectly connected to the nozzle body by means of at least one supply line, so that an air current generated by the fan can be ejected from the plurality of ejection nozzles and/or from the flow guiding contour for the purpose of cleaning and/or de-icing the see-through area in the form of a guided air current. The fan can, for example, also be part of a cooling system of the roof module, the supply line then being connected to the cooling channel in the form of a bypass (the fan only being indirectly connected to the nozzle body by means of the supply line in this case). However, a direct, immediate connection between the fan and the nozzle body via the supply line is also possible. In this case, the fan preferably replaces the compressed-air components used in the prior art. The fan can be disposed in the roof module. The air inlet does not necessarily have to be disposed on the roof module, but can alternatively also be provided in another area of the vehicle, for example in a rear compartment. It is only important that the fan is connected to the air inlet via a supply line and is connected to the nozzle body via a supply line. This means that the fan can, for example, suction air from outside through the air inlet and guide it to the nozzle body via the supply line. The suctioned air can then be ejected from the nozzle body through the plurality of ejection nozzles and is preferably deflected towards the see-through area. Preferably, the air can be preheated within the supply lines so that the air can heat the see-through area when it strikes it. In this manner, a de-icing function can be provided to de-ice the see-through area. The air can be preheated, for example, by using waste heat from one or more electronic components, which may be installed in the roof module, via heat exchangers.

In a particularly preferred embodiment, the at least one cleaning apparatus is preferably connectable directly or indirectly to a fan of an air-conditioning system of a motor vehicle by means of a supply line so waste air provided by the air-conditioning system can be supplied to the nozzle body by means of the fan and can be ejected from the plurality of ejection nozzles and/or the flow guiding contour in the form of a guided air current for the purpose of cleaning and/or de-icing the see-through area. Preferably, a motor vehicle therefore has at least one air-conditioning system having a fan and a roof module according to the invention (as well as its embodiments). The nozzle body can preferably be connected to the air-conditioning system, e.g. an air-conditioning duct of the air-conditioning system, by means of the supply line. In a connection of this kind, the supply line forms a bypass to the air-conditioning system. Waste air from the air-conditioning system can then be supplied to the nozzle body as supply air via the bypass through the supply line. The at least one cleaning apparatus is preferably connected directly or indirectly (i.e., via a duct, for example) to the fan of the vehicle's air-conditioning system by means of a supply line, so that wastes air provided by the air-conditioning system can be supplied to the nozzle body by means of the fan. The air supplied in this manner to the flow guiding contour and/or the nozzle body can then be ejected from the plurality of ejection nozzles in the form of a guided air current for the purpose of cleaning and/or de-icing the see-through area. Ideally, therefore, supply air to the flow guiding contour and/or the nozzle body is provided by the waste air of the vehicle's cooling system and conveyed via the cooling system's own fan to the nozzle body via at least one supply line. This means no additional components, such as an additional fan, are required, so that much installation space can be saved. In this embodiment, no additional consumers, e.g. in the form of an additional fan, are required either, so that this solution can be designed to be much more compact and less expensive. In addition, the waste air from the cooling system is already preheated by the vehicle interior, so that warm air can be provided for a de-icing function in a cost-effective manner without requiring additional energy. The warm waste air from the cooling system can heat the see-through area and thus take over the de-icing function.

In the present case, the term “fan” refers to a fan or a type of (externally) driven turbomachine which conveys a gaseous medium, for example air. For this purpose, the fan can, for example, have an impeller which has an axial or radial flow and usually rotates in a casing. The fan can be designed in the form of an axial fan, a diagonal fan, a radial/centrifugal fan, a tangential or cross-flow fan or the like.

In a preferred embodiment, a supply line of the cleaning apparatus interacts in such a manner with the environment sensor that waste heat of the environment sensor can be dissipated via the supply line and in doing so preferably heats a cleaning fluid flowing via the supply line. In other words, the supply line preferably serves as a flow channel, which is particularly preferably in heat-conducting contact with the environment sensor, i.e., is disposed at least indirectly on the environment sensor, for example. This enables heat to be transferred from the environment sensor to the supply line. Particularly preferably, air duct fins and/or cooling fins of a heat sink, which is used to cool the environment sensor, serve as heat transfer fins for heat transfer to the supply line of the cleaning apparatus. The supply channel thus preferably forms part of a heat exchanger.

The aim is to achieve a flow distribution which is as constant as possible over the entire area of the flow channel and/or supply channel. Particularly preferably, the supply channel can also be extended by at least one attachment point to a vehicle body frame or to the panel component. This design heats the air and effectively cools the environment sensor. The heated waste air can then be directed past the environment sensor, for example above or below it in the direction of the cooling device.

The type of environment sensor installed in the roof module is generally arbitrary. The cooling provided in the roof module according to the invention is particularly advantageous when using lidar sensors and/or radar sensors and/or camera sensors and/or multi-camera sensors.

It is understood that the embodiments and exemplary embodiments mentioned above and to be explained below can be formed not only individually, but also in any combination with one another without departing from the scope of the present invention. Moreover, all embodiments and exemplary embodiments of the roof module relate in their entirety to a motor vehicle having such a roof module.

### BRIEF DESCRIPTIONS OF THE DRAWINGS

An embodiment of the invention is shown schematically in the drawing and is explained exemplarily in the following.

FIG. 1 shows a perspective view of a vehicle roof of a motor vehicle having a roof module according to the invention;

FIG. 2 shows a schematic view of a first exemplary embodiment of a cleaning apparatus;

FIG. 3 shows a lateral view of a second exemplary embodiment of a cleaning apparatus;

FIG. 4 a lateral view of third exemplary embodiment of a cleaning apparatus;

FIG. 5 shows a schematic view of an exemplary embodiment of a nozzle body;

FIG. 6 shows a schematic view of a fourth exemplary embodiment of a cleaning apparatus;

FIG. 7 shows a schematic view of a fifth exemplary embodiment of a cleaning apparatus;

FIG. 8 shows a schematic view of a supply channel for heat transfer;

FIG. 9 shows a schematic view of a second exemplary embodiment of a nozzle body;

FIG. 10 shows a schematic view of a third exemplary embodiment of a nozzle body;

FIG. 11 shows a schematic view of a sixth exemplary embodiment of a cleaning apparatus;

FIG. 12 shows a schematic view of a seventh exemplary embodiment of a cleaning apparatus; and

FIG. 13 shows a schematic view of an eighth exemplary embodiment of a cleaning apparatus.

### DETAILED DESCRIPTION

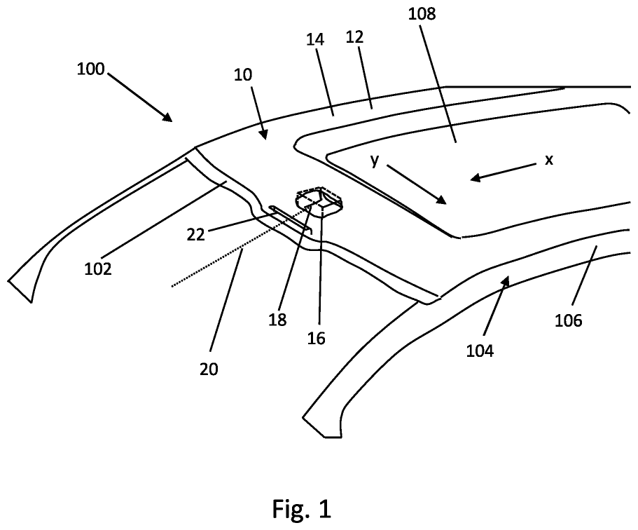

FIG. 1 shows a vehicle roof 100 comprising a roof module 10. The roof module 10 comprises a panel component 12 for forming a roof skin 14 of the vehicle roof 100 of a motor vehicle (not shown in full). An environment sensor 16 is disposed symmetrically to the vehicle longitudinal axis x in a frontal area of the vehicle roof 100 and/or the roof module 10, as viewed in a longitudinal direction x of the vehicle. The environment sensor 16 is disposed directly behind a front transverse beam 102, which defines a roof-side front header of the vehicle. The roof module 10 is preferably inserted as a structural unit in a roof frame 104 of the vehicle and/or placed on the at least two transverse beams 102 and at least two longitudinal beams 106, via which the roof frame 104 is formed. The roof module 10 in the exemplary embodiment shown has a panoramic roof 108.

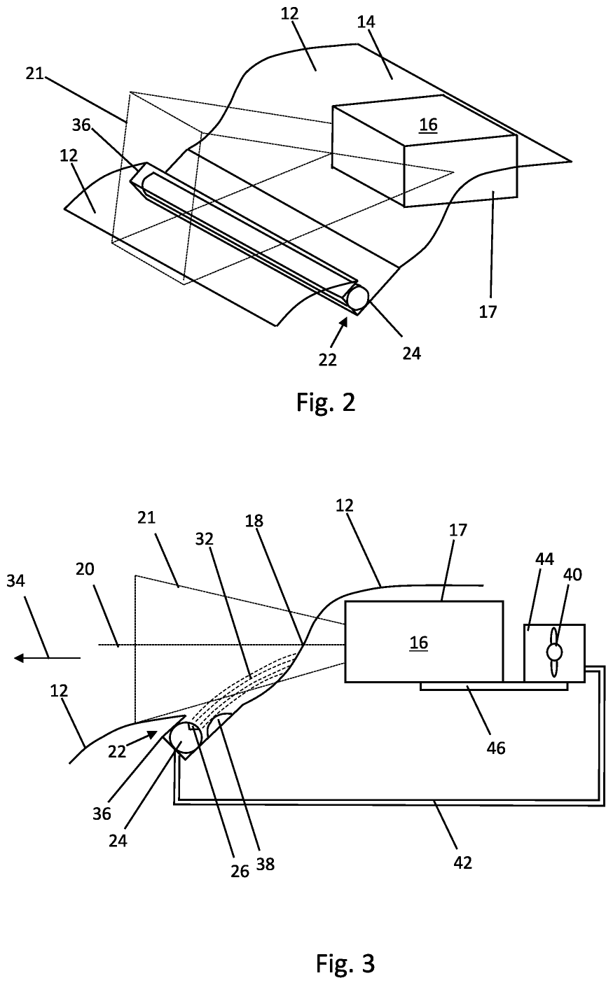

The environment sensor 16 looks through a see-through area 18, which can be provided, for example, on a casing 17 of the environment sensor 16 or can also be formed by panel component 12. The see-through area 18 can, for example, be made of a preferably shatterproof plastic or other (partially) transparent material and be embedded in the casing 17 of the environment sensor 16 or also in the panel component 12 in the manner of a window. In the case of FIGS. 2 and 3, the casing 17 is disposed below the panel component 12 and is covered by it. The see-through area 18 is provided in the panel component 12. The environment sensor 16 in the present case is a lidar sensor which can send and/or receive electromagnetic signals to detect the vehicle environment through the see-through area 18. Other sensor types, e.g., (multidirectional) cameras, can also be used. The environment sensor 16 is oriented along an optical axis 20, which in the case of FIG. 1 is oriented parallel to the longitudinal direction x of the vehicle. The environment sensor 16 comprises a field of view 21 extending essentially conically around the optical axis 20, the environment sensor 16 being able to detect the surroundings of the vehicle within the field of view 21. The field of view 21 is shown schematically by dashed lines in FIGS. 2 and 3.

A cleaning apparatus 22 is also disposed on the panel component 12 according to the invention. The cleaning apparatus 22 comprises an essentially oblong nozzle body 24 having a plurality of ejection nozzles 26. The nozzle body 24 is shown in isolated form in FIG. 5, whereby it can be seen that the plurality of ejection nozzles 26 can be provided in the form of holes, for example. The nozzle body 24 is essentially tubular in shape and has a hollow cross section. Alternatively, it can also be tubular or in the form of a porous membrane. The nozzle body 24 extends along a longitudinal axis 28, which in the case shown in FIG. 1 is oriented parallel to a vehicle width direction y. The individual ejection nozzles 26 are each oriented essentially in the same direction to one another, i.e., they are oriented parallel to one another. A respective ejection direction 30 (for an ejection nozzle 26 in FIG. 5, for example) of the respective ejection nozzles 26 extends orthogonally to the longitudinal axis 28 of the nozzle body 24.

The nozzle body 24 is oriented in such a manner with the plurality of ejection nozzles 26 in relation to the see-through area 18 that an air current 32 (see FIG. 3) can strike the see-through area 18 from the outside, preferably along a movement direction 34, in order to clean or de-ice it, for example.

For the arrangement of the nozzle body 24, the panel component according to the invention comprises a guide channel 36. In the case of FIGS. 1 to 3, the panel component 12 has the guide channel 36, as viewed along the optical axis 20 of the environment sensor 16, in the movement direction 34 in front of the see-through area 18. The guide channel 36 extends essentially longitudinally and is at a rearward offset with respect to the outer surface of the roof skin 14 in the direction of a vehicle interior. The guide channel 36 is designed to at least partially receive the at least one nozzle body 24. In the present case, the guide channel 36 completely receives the nozzle body 24. For this purpose, as can be seen from FIGS. 2 and 3, the guide channel 36 has an essentially rectangular cross section in which the nozzle body 24 is disposed. The guide channel 36 preferably extends in the longitudinal direction 28 to such an extent that the entire nozzle body 24 is received in the guide channel 36. In other words, as viewed in the longitudinal direction 28, the guide channel 36 is as large as the nozzle body 24. For this purpose, the guide channel 36 is recessed in the roof skin 14 in the manner of a groove or channel. In the present case, the nozzle body 24 is disposed in a stationary position in the guide channel 36. In principle, the nozzle body can also be disposed in the guide channel 36 so that it is stationary and at least partially rotatable about a rotational axis. The rotational axis can preferably coincide with the longitudinal axis 28 of the nozzle body 24.

As can be seen from FIG. 3, at least one flow guiding contour 38 can be provided in the area of the guide channel 36, an air current 32 ejected from the plurality of ejection nozzles 26 being able to be guided along the flow guiding contour 38 in the direction of the see-through area 18 by means of the flow guiding contour 38. In the case of FIG. 3, the flow guiding contour 38 has an essentially semicircular cross section (with a section along the longitudinal vehicle direction x and a vertical vehicle direction z).

The air current for the cleaning apparatus 22 according to the invention can be provided by means of a fan 40. In one exemplary embodiment, the roof module 10 can comprise the fan 40 for this purpose. An air inlet (not shown in detail) is then preferably provided on the roof module 10. The fan 40 is directly or indirectly connected to the nozzle body 24 by means of at least one supply line 42, meaning an air current generated by the fan 40 can be ejected from the plurality of ejection nozzles 26 in the form of the guided air current 32 for the purpose of cleaning and/or de-icing the see-through area 18. In the present case, the fan 40 is indirectly connected to the nozzle body 24 via the supply line 42. The supply line 42 is connected to a cooling channel 44 (which is not shown in detail) of the roof module 10. The fan 40 and other cooling components are located in the cooling channel 44, for example. In the present case, the cooling channel 44 is connected to the environment sensor 16 and/or the casing 17 via a heat-conducting element 46. Waste heat from the environment sensor 16 is dissipated to the cooling duct 44 via the heat-conducting element 46 and heats the waste air, which is then (also) conveyed to the supply line 42 by the fan. This waste air is supplied to the nozzle body 24 as supply air via the supply line 42 and is ejected from the ejection openings and/or ejection nozzles 26. The preheated air can be used to de-ice the see-through area 18.

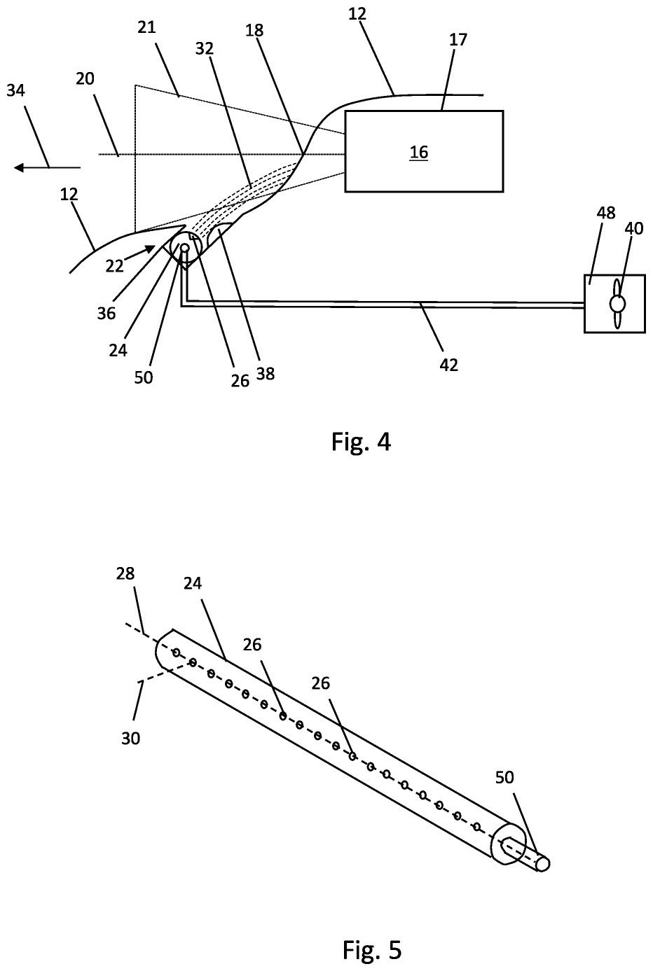

In an alternative exemplary embodiment, as can be seen in FIG. 4, the cleaning apparatus 22 can be connected to the fan 40 of an air-conditioning system 48 of the motor vehicle, so that waste air provided by the air-conditioning system can be supplied to the nozzle body 24 by means of the fan 40 and can be ejected from the plurality of ejection nozzles 26 in the form of the guided air current 32 for the purpose of cleaning and/or de-icing the see-through area 18. The fan 40 is also connected to the nozzle body via the supply line 42.

A connection between the nozzle body 24 and the supply line 42 can be made independently of the remaining embodiment, for example via a connection fitting 50 (see FIG. 5), which can be disposed at one end of the nozzle body 24. An opposite end of the nozzle body 24, on the other hand, is preferably sealed so as to be impermeable to air.

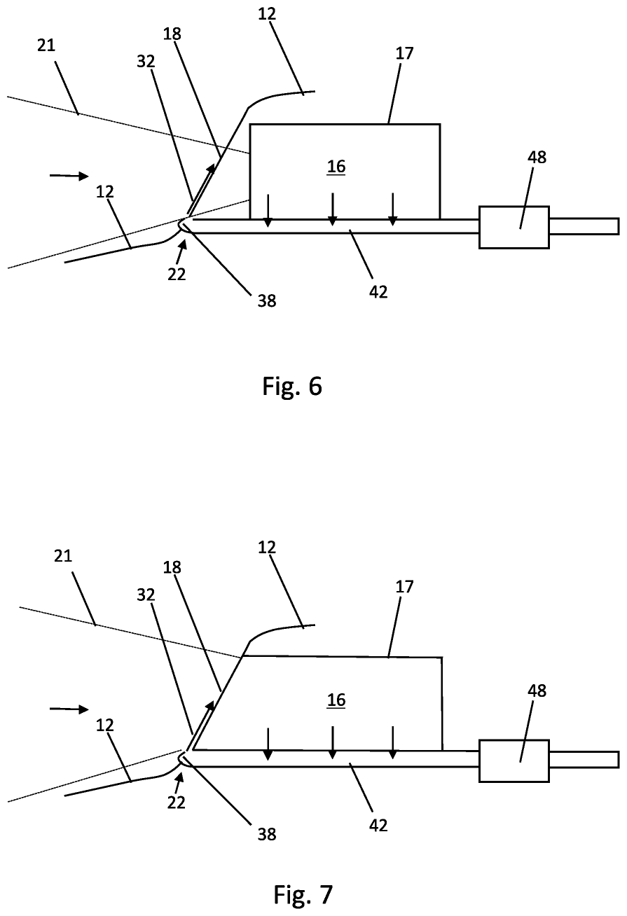

FIG. 6 shows a fourth exemplary embodiment according to the invention, in which the cleaning apparatus 22 comprises the flow guiding contour 38 without a nozzle body being provided. The cleaning fluid, for example an air current, is guided to the flow guiding contour 38 via the supply line 42 and deflected and preferably accelerated at the flow guiding contour 38 in such a manner that it is ejected in the direction of the see-through area in order to clean it. In the present case, the flow guiding contour 38 is formed by a geometric design of the panel component 12, in particular by a corresponding shaping during the manufacturing of the panel component 12. In the present case, the cleaning fluid flow is also provided by the fan 40, which can be disposed, for example, in a trunk or a front area of the motor vehicle. In the present case, the cleaning fluid flow is preheated by waste heat from the environment sensor 16, which preferably transfers its waste heat to the cleaning fluid via one or more heat-conducting elements 46. In the present case, the supply line 42 is in direct heat-transferring contact with the casing 17 of the environment sensor 16, so that the heat can be transferred to the cleaning fluid via this thermal bridge. The supply line 42 is disposed below the casing 17 of the environment sensor 16 for this purpose. Alternatively, the supply line 42 can also be disposed above or to the side of the casing 17. In addition, the supply line 42 can also be connected only indirectly to the environment sensor 16 or other heat-emitting components of the roof module 10 and/or the motor vehicle in order to absorb heat therefrom. For example, it is possible for components to be connected via heat conduction pipes.

FIG. 7 differs from FIG. 6 only in that the flow guiding contour 38 is formed on the casing 17 of the environment sensor 16. This is preferably realized by the casing 17 being adapted accordingly in the area of the flow guiding contour 38.

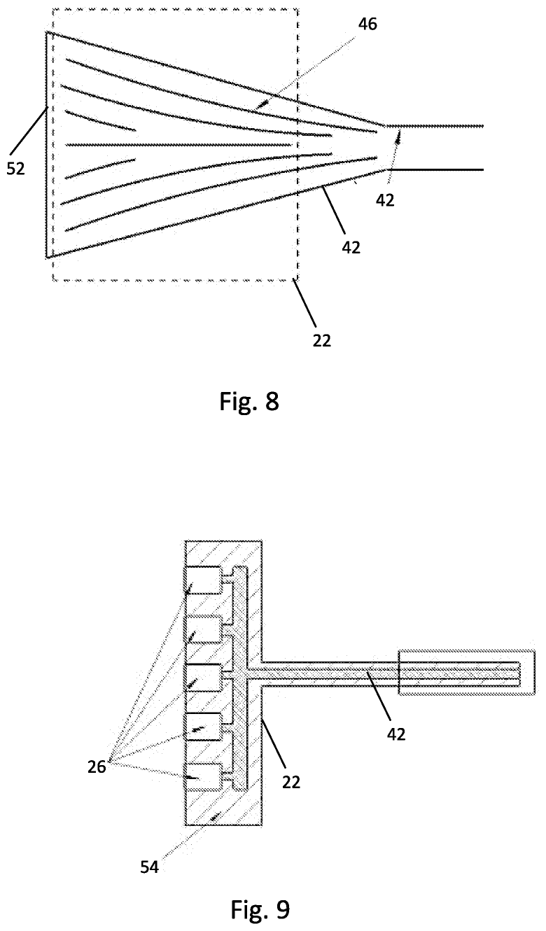

FIG. 8 shows a cross-sectional view of an exemplary embodiment of the supply line 42, which shows the heat-conducting elements 46, for example several heat-exchanging fins and/or surface elements, can be provided directly in the supply line 42 in order to be able to transfer heat to the cleaning fluid more effectively in this manner. As can be seen in FIG. 8, the supply channel 42 opens conically in the direction of a cleaning fluid ejection 52. A width of the cleaning fluid ejection 52 is preferably determined on the basis of a width of the see-through area 18.

FIG. 9 shows an exemplary embodiment of a nozzle body 24 according to the invention. In the present case, the nozzle body 24 is integrated in a support element 54, in which the supply line 42 is also provided. The support element 54 can, for example, be formed from an aluminum and/or plastic block. In the present case, the support element 54 is formed in one piece. In the present case, air is guided through the supply line 42 as a cleaning fluid.

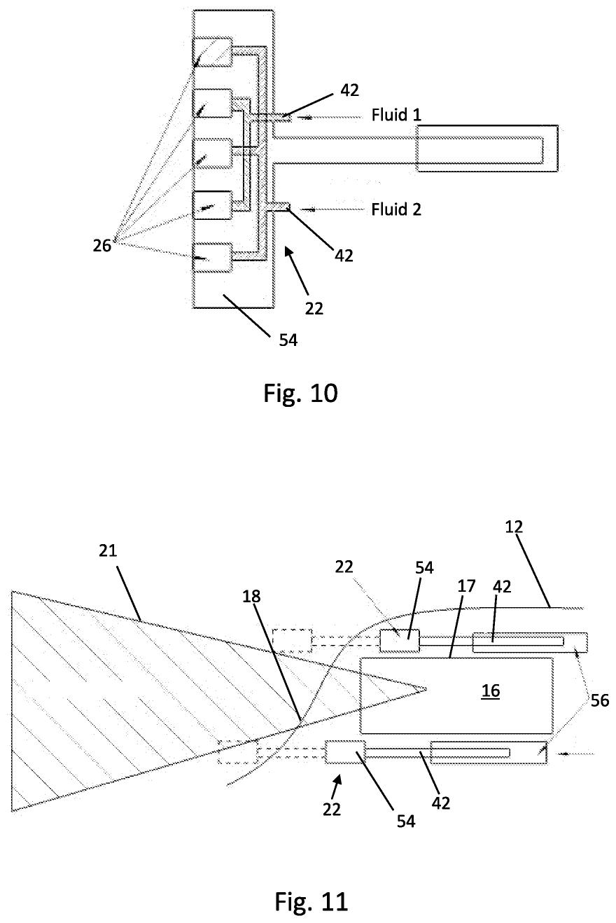

FIG. 10 shows another exemplary embodiment example of a nozzle body 24 according to the invention. It can be seen that the nozzle body 24 according to this exemplary embodiment is also designed as a support element 54 or is integrated in such an element. In this exemplary embodiment, the nozzle body 24 and/or the cleaning apparatus 22 comprises several supply lines 42, which can be supplied with various cleaning fluids. Starting from the supply lines 42, several of the plurality of ejection nozzles 26 are actuated, so that a first cleaning fluid, for example air, can preferably be ejected from a part of the ejection nozzles 26 and a second cleaning fluid, for example soapsuds, can be ejected from the other part of the ejection nozzles 26.

FIG. 11 shows an exemplary embodiment of the cleaning apparatus 22, in which the nozzle body 24 is disposed both above and below the environment sensor 16 so as to be movable in and out translationally by means of the support element 54. In the event of cleaning, the nozzle body 24 or the nozzle bodies 24 can be extended in order to clean the see-through area 18. The extended position of the nozzle body 24 or the support elements 54 is indicated by a dashed line. In the case shown, the nozzle body 24 can be telescopically retracted and extended. A displacement mechanism 56 is only shown schematically. According to this exemplary embodiment, the roof module 10 therefore comprises two cleaning apparatuses 22.

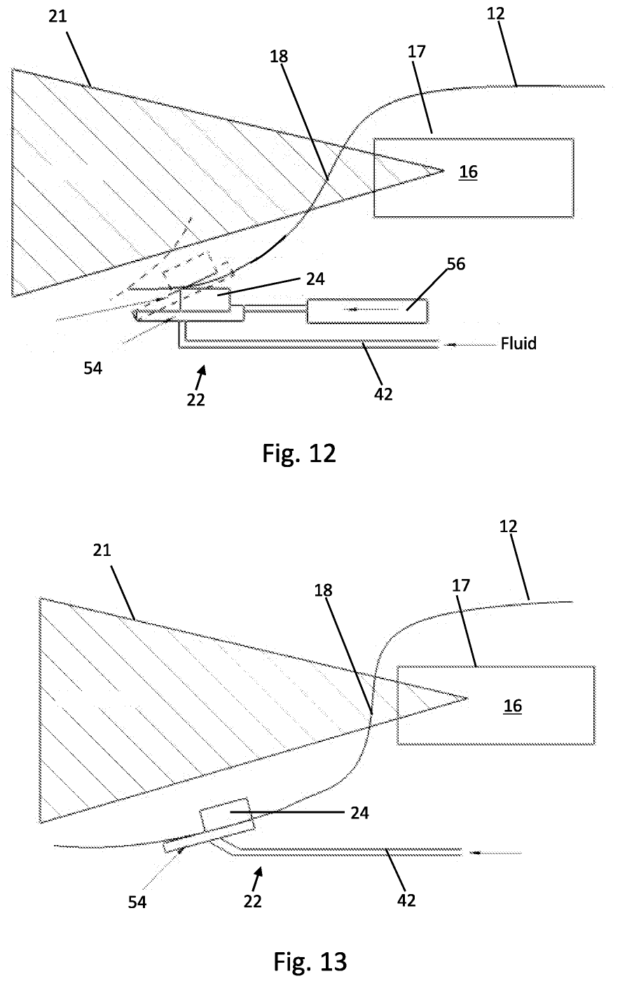

FIG. 12 shows another embodiment of the cleaning apparatus 22, in which the nozzle body 24 is disposed on a support element 54 and can be telescopically retracted and extended via this by means of the displacement mechanism 56. The cleaning apparatus 22 is disposed below the environment sensor 16. The supply line 42 is connected to the nozzle body 24. The nozzle body 24 is disposed rigidly on the support element 54, so that only the support element 54 has to be retracted and extended.

FIG. 13 shows another exemplary embodiment of the cleaning apparatus 22, in which the nozzle body 24 is rigidly disposed on a support element 54. The support element is immovably disposed on the panel component 12, in particular below the panel component 12. The support element 54 serves in particular as a mounting platform for mounting the nozzle body 24. In this embodiment, the nozzle body 24 can therefore not be retracted or extended.

1. A roof module for forming a vehicle roof on a motor vehicle, the roof module having:
a panel component, whose outer surface forms at least sections of a roof skin of the motor vehicle,
the roof skin acting as an outer sealing surface of the roof module,
the roof module having at least one environment sensor which sends and/or receives electromagnetic signals for charting the vehicle environment via a see-through area and having at least one cleaning apparatus by which the see-through area is cleaned,
wherein the cleaning apparatus comprises an essentially oblong nozzle body having a plurality of ejection nozzles and/or a flow guiding contour formed by the panel component or by the environment sensor.

2. The roof module according to claim 1, wherein the nozzle body is essentially tube- or hose-shaped, having a hollow cross section.

3. The roof module according to claim 1, wherein the plurality of ejection nozzles is provided in the form of a plurality of holes and/or slits in the nozzle body.

4. The roof module according to claim 1, wherein the plurality of ejection nozzles is disposed in such a manner in the nozzle body that the individual ejection nozzles are each oriented essentially in the same or a different direction in relation to the see-through area.

5. The roof module according to claim 1, wherein the nozzle body is formed in the manner of a tube-shaped membrane, at least sections of which are sealed in an airtight manner by means of a seal lacquer coat.

6. The roof module according to claim 1, wherein the nozzle body having the plurality of ejection nozzles is oriented in such a manner in relation to the see-through area that an air current strikes the see-through area from the outside, along a movement direction.

7. The roof module according to claim 1, wherein the panel component, as viewed along an optical axis of the environment sensor, has an essentially oblong guide channel in front of the see-through area, the guide channel being at a rearward offset in the direction of a vehicle interior with respect to the outer surface of the roof skin and is configured for at least partially receiving the at least one nozzle body.

8. The roof module according to claim 7, wherein the guide channel is inserted in the roof skin in the manner of a groove or a channel.

9. The roof module according to claim 7, wherein the nozzle body is disposed in a stationary manner in the guide channel and is pivotable in the guide channel at least in sections around a rotation axis.

10. The roof module according to claim 7, wherein the at least one flow guiding contour is provided in an area of the guide channel and guides an air current ejected from the plurality of ejection nozzles in the direction of the see-through area.

11. The roof module according to claim 1, wherein the flow guiding contour is designed to form a constriction in the panel component, through which the air current is accelerated in the direction of the see-through area.

12. The roof module according to claim 1, wherein the nozzle body is integrated in a support element or is disposed thereon and/or is moveable, translationally and/or rotationally, in relation to the see-through area.

13. The roof module according to claim 1, wherein the roof module comprises a fan of a vehicle cooling system, and an air inlet, the fan being directly or indirectly connected to the nozzle body by at least one supply line so an air current generated by the fan is ejected from the plurality of ejection nozzles in the form of a guided air current for the purpose of cleaning and/or de-icing the see-through area.

14. The roof module according to claim 1, wherein the at least one cleaning apparatus is connectable directly or indirectly to a fan of an air-conditioning system of a motor vehicle so waste air provided by the air-conditioning system is supplied to the nozzle body by the fan and is ejected from the plurality of ejection nozzles in the form of a guided air current for the purpose of cleaning and/or de-icing the see-through area.

15. The roof module according to claim 1, wherein the at least one environment sensor is configured in the manner of a lidar sensor and/or in the manner of a radar sensor and/or in the manner of a camera sensor and/or in the manner a multi-camera sensor.

16. The roof module according to claim 1, wherein a supply line of the cleaning apparatus interacts in such a manner with the environment sensor that waste heat of the environment sensor is dissipated via the supply line and in doing so heats a cleaning fluid flowing via the supply line.

17. A motor vehicle, comprising a roof module according to claim 1.

18. A roof module for forming a vehicle roof on a motor vehicle, the roof module having:
a panel component, whose outer surface forms at least sections of a roof skin of the motor vehicle and which acts as an outer sealing surface of the roof module,
the roof module having at least one environment sensor which sends and/or receives electromagnetic signals for charting the vehicle environment via a see-through area and having at least one cleaning apparatus, which comprises at least one ejection nozzle by which the see-through area is cleaned,
wherein the cleaning apparatus is connected to a fan at least via a supply line so an air current generated by the fan is ejected from the at least one ejection nozzle for the purpose of cleaning and/or de-icing the see-through area.

19. The roof module according to claim 18, wherein the fan is comprises in the roof module or that the fan is an air-conditioning system of a motor vehicle.

20. The roof module according to claim 1, wherein the cleaning apparatus comprises several supply lines, which are exposed to different cleaning fluids.
